(19) United States
(12) Patent Application Publication
(10) Pub. No.: US 2014/0223818 A1
(43) Pub. Date: Aug. 14, 2014

(54) Filtration system for use in aquariums

(71) Applicant: Ryan Coghlan, Corvallis, OR (US)

(72) Inventor: Ryan Coghlan, Corvallis, OR (US)

(21) Appl. No.: 13/766,117

(22) Filed: Feb. 13, 2013

(51) Int. Cl. A01G 31/02; A01G 1/00

(52) U.S. Cl. CPC A01G 31/02; A01G 1/001
USPC 47/62 R; 47/59 R

(57) ABSTRACT

An inexpensive aquaponic conversion kit for aquariums that uses a combination of mechanical, biological, and chemical filtration components along with terrestrial plants to filter aquarium water. The system includes a funnel shaped undergravel filter that concentrates solid waste towards an airlift pump that transports solid and liquid waste into a planter containing terrestrial plants. These waste nutrients are trapped in the planter in layers of activated carbon and filamentous material that adsorb and trap waste particles where the roots of plants turn the waste into biological material and aid in cleaning the tank. A grow light and hood are able to be attached to a bracket at the back of the planter to grow healthy plants.

### CROSS-REFERENCES TO RELATED APPLICATIONS

This application claims priority to U.S. Provisional Patent Application Ser. No. 61/598,244 filed on Feb. 13^{th}, 2012 entitled “A small scale aquaponic planter and aquarium system for use at the home or office”, the disclosure of which is hereby incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

This invention relates generally to the field of aquaponics and/or hydroponic planters for growing traditional soil-grown plants such as herbs and flowers in a soil-less environment.

2. Description of the Related Art

Aquaponics is the symbiotic technology of growing plants hydroponically (without organic growing material such as dirt) using aquatic animal waste as the primary nutrient source. Traditional hydroponic systems use a full spectrum of plant macro and micro nutrients derived from natural or unnatural sources which are dissolved in water in a nutrient reservoir which is then pumped or poured over the roots of plants. High concentrations of nutrients and large amounts of gas exchange allow hydroponic plants to achieve extremely efficient growth rates. Aquatic animals such as fish naturally produce waste as they metabolize food and oxygen. This waste is then degraded by microorganisms into macro and micro nutrients that make nearly complete plant fertilizer. Fish produce liquid waste in the form of ammonia and solid waste that is degraded by microorganisms into ammonia and other nitrogenous wastes. These ammonia waste products are poisonous to aquatic animals and converted via biological filtration first into nitrite, another poisonous waste product, and then into relatively non-poisonous nitrate by Nitrosoma and Nitrobacter communities of naturally occurring bacteria. An aquaponic system with established bacterial communities and a steady stream of fish waste can generate plant growth equal to or greater than that of traditional hydroponic technologies.

Hydroponic systems are related to aquaponic systems in that they use neutral or inert growth media such as gravel, pearlite, expanded clay, etc. as a means to support plant roots and maintain moisture levels for the roots. Hydroponic systems generally use liquid nutrients derived from natural or un-natural sources, which are broken down into their purest forms before being added to a hydroponic growth system. There are generally no solid or liquid waste particles that need to be degraded by microorganisms in a hydroponic system.

Prior art in U.S. Pat. No. 5,385,590 describes one such small personal hydroponic system. In this system, a nutrient solution is added to the bottom reservoir which is then intermittently pumped into a bed of inert media on top, which then drips back into the lower reservoir through simple flat drainage holes. While this system works fine with dissolved hydroponic nutrients, waste from fish or other aquatic animals contains waste particles of various sizes that need to be captured and degraded naturally to maintain a clean and healthy aquarium environment. In the same system, roots from the terrestrial plants tend to find flat drainage holes and grow down into the nutrient reservoir. Over time these roots can clog the drainage holes, which can drown the plant due to a flooded planter. The roots can also become unsightly in the case of an aquaponic system, as they fill the aquarium and choke out aquatic life.

Traditional aquaponic systems cycle water from a fish reservoir to a separate plant reservoir indefinitely. Plant roots absorb waste nutrients from the water and turn the nutrients into plant material, cleaning the water for addition into the fish reservoir. Aquaponic systems are usually composed of many components including large fish tanks, plant growth beds filled with inert media, natural or artificial lighting sources, mineralization tanks, sump tanks, electric pumps and solid waste filtering mechanisms. These systems have the ability to produce great quantities of produce and harvestable fish but can cost many thousands of dollars in material costs, require a large area for growth, and require many hours of labor for installation and maintenance.

Aquaponic technology is scalable and can be applied to small scale aquarium systems. Hobby aquarists use mechanical, biological and chemical filtration in their aquariums to make healthy and clean environments for aquatic animals such as fish to live. These systems often employ the use of rotary impellor pumps or airlift pumps to suck dirty water from an aquarium, clean it by means of filtration, and then return the water back to the aquarium. Over time solid waste accumulates in the bottom of the fish tank, requiring the aquarium substrate to be vacuumed on a regular basis. This solid waste also creates a great deal of ammonia as it decomposes, which is converted via nitrification into nitrate and leads to high levels of nitrate in the aquarium water. At low levels nitrate is non-toxic to aquatic animals but becomes toxic at high levels and can lead to unsightly and potentially deadly algae blooms in an aquarium. Aquarists therefore need to perform weekly water changes of around 25% total volume to lower overall nitrate levels in the aquarium. Chemical filtration in the form of activated carbon and zeolite is also used my aquarists to adsorb nitrogenous waste, but needs to be removed and replaced on a regular basis as the adsorptive capacity of these particles becomes saturated over time. Aquaponic technology uses plants to lower this nitrate level naturally but turning excess waste into plant material, thereby reducing the need to perform water changes and also greatly decreasing the amount of algae growing in the aquarium.

Another downfall of current aquarium filtration mechanisms is the inability to gather solid waste, or mulm, that accumulates on the bottom of the aquarium. Undergravel filters use airlift pumps or impellor pumps to create a low pressure zone under the aquarium substrate, creating a constant flow of oxygenated water through the aquarium substrate at the bottom of a tank. This oxygenated water allows nitrifying bacteria to partially decompose this solid waste, but vacuuming of the aquarium substrate at the bottom of the tank is often necessary to remove large waste particles. Without occasional vacuuming, these undergravel filters tend to compact and become plugged with solid waste, having a detrimental effect on the aquarium chemistry and health of the system.

It is therefore an object of this invention to create an attractive, affordable and easy to use aquaponic aquarium system that keeps pet fish or other aquatic animals healthy while growing terrestrial plants as a part of the aquarium filter mechanism. It is also an object of this invention to create a unique undergravel filtration system to decrease aquarium cleaning requirements by pumping aquarium waste directly to the roots of growing plants.

U.S. Pat. No. 5,385,590 describes a hydroponic planter for the home. This system contains a nutrient reservoir, planter, and accompanying air pump and timer included in its assembly.

U.S. Pat. No. 5,618,428 describes a filtration system that uses a terrestrial plant and aquarium filter combination to clean aquarium water. The plant grows in a typical pot and then its roots are allowed to exit the bottom of the pot into a filter cartridge that is part of the filter mechanism of the fish tank.

A terrarium/aquarium combination in U.S. Pat. No. 4,754,571 shows plants growing side by side with an aquarium, separated by a vertical partition. This combination provides a mechanism for increasing the humidity of the terrarium while maintaining separate terrarium and aquarium portions of the system. There are also filter plates beneath the terrarium media and in the aquarium and allow water flow through.

### BRIEF SUMMARY OF THE INVENTION

In accordance with the invention, a small scale aquaponic aquarium system is provided that uses compressed air to pump waste-laden water and solid waste from an aquarium into a self-contained planter above the aquarium. This planter has layers of hydroponic growth media along with chemical filtration components for the roots of terrestrial plants to grow. Within this hydroponic planter exists a watering tube with holes that allow for the even distribution of highly oxygenated water and mulm throughout the planter. Water dispensed from the watering tube then trickles through the hydroponic growth media into the bottom of the planter and then escapes through raised drainage holes within the container, dripping back into the aquarium via gravity. An airline input junction exists at the back of the planter which connects to an external air pump. An airline runs through the planter to a riser tube in the center of the planter and down the inside of said riser tube to an airline output at the bottom of a riser tube. Compressed air is released at the bottom of this riser tube which in turn creates an ‘airlift’ system that pumps water and waste up into the planter. At the bottom of the riser tube exists a solid waste capture funnel under an undergravel filter screen. This funnel and screen system concentrates mulm to the input of the riser tube, where it is pumped into the planter for subsequent degradation and utilization by plant roots. Water pools in the planter and is released via raised drainage holes in the bottom of the planter back into the aquarium, cleaned and oxygenated for the cycle to begin again. Attached to the back of the planter is a bracket that allows a grow light to be attached, allowing for efficient plant growth.

Another embodiment of this invention is shown in FIGS. 5 through 7, respectively. This embodiment functions in a similar manner to the first embodiment, but is an application of the invention for rectangular aquariums and has parts that look different than those in the first embodiment but perform the same function within the invention. Equivalent parts will be labeled with a ‘b’ suffix in all figures and descriptions.

### BRIEF DESCRIPTION OF THE SEVERAL VIEWS OF THE DRAWING(S)

FIG. 1 is a perspective view of the preferred embodiment of the aquaponic planter and aquarium;

FIG. 2 is an exploded view of the aquaponic setup of FIG. 1 with each part of the system labeled.

FIG. 3 is a cross sectional perspective view of the back half of the planter from FIG. 1 and its separate components.

FIG. 4 is a cross sectional view of the planter and solid waste capture funnel apparatus without the aquarium, grow light, or fibrous mat shown.

FIG. 5 is a perspective view of another embodiment of this invention, for use with common rectangular aquariums.

FIG. 6 is a perspective view of the planter in embodiment shown in FIG. 5, basic construction shown without fibrous mat, net baskets, growth plugs, or plants shown.

FIG. 7 is an exploded view of the embodiment shown in FIG. 5.

FIG. 8 is a perspective view of a possible funnel shaped undergravel filter unit for use with the embodiment shown in FIG. 5.

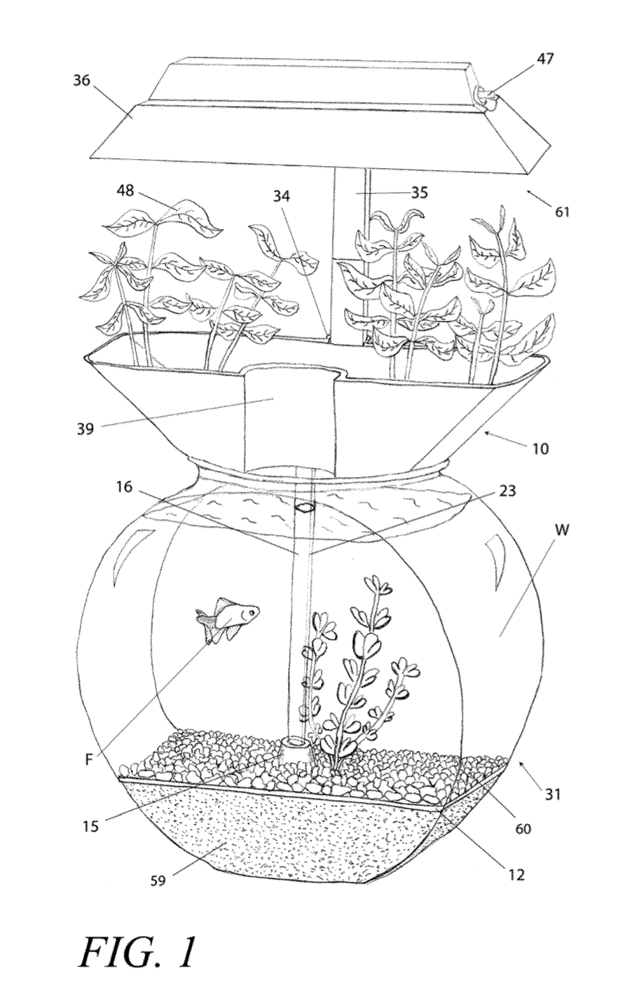

While the invention will be described in connection to the preferred embodiment in FIG. 1, it will be understood that it is not intended to limit the invention to that embodiment. This description is intended to cover all alternatives, modifications and equivalents that may be included within the spirit and scope of the invention as defined by the appended claims.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the specification and drawings, appropriately interpreted, along with the full range of equivalents to which the specification and drawings are entitled.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

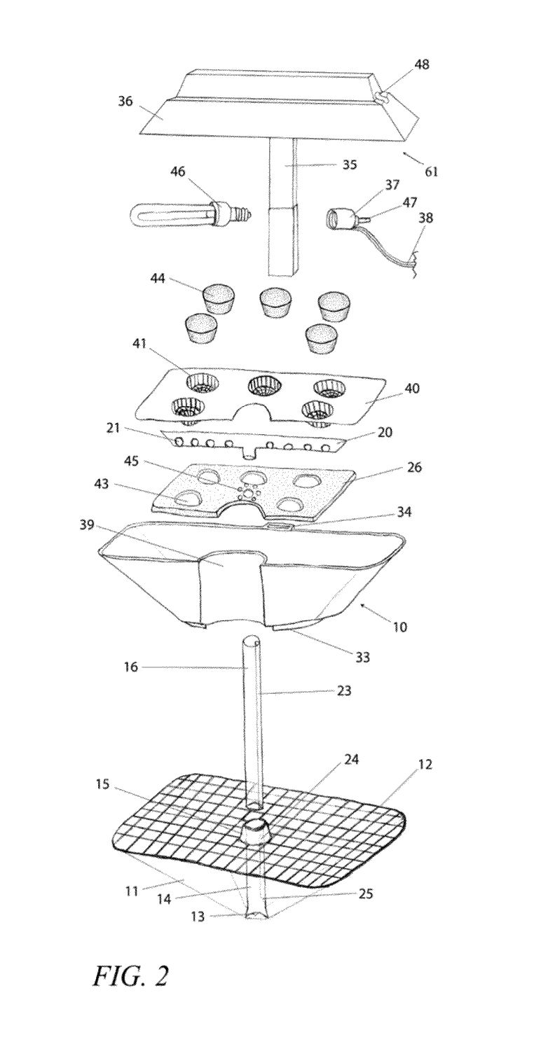

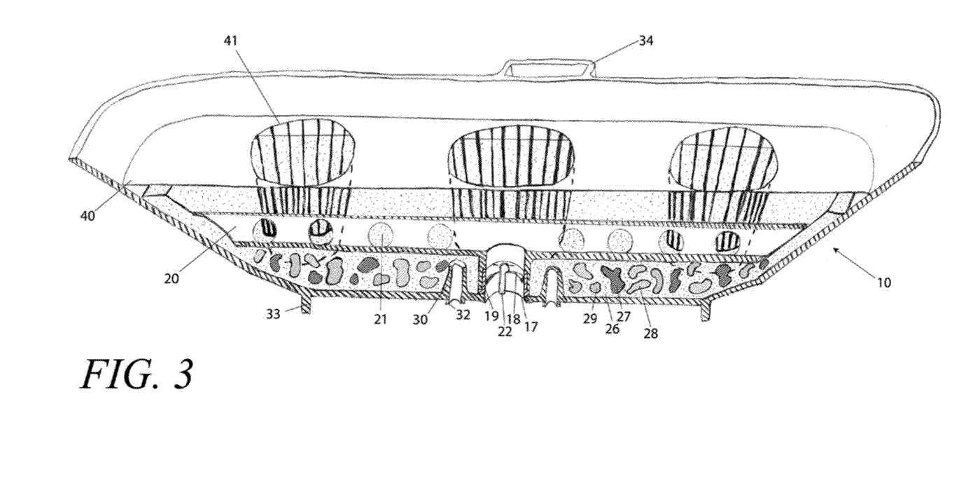

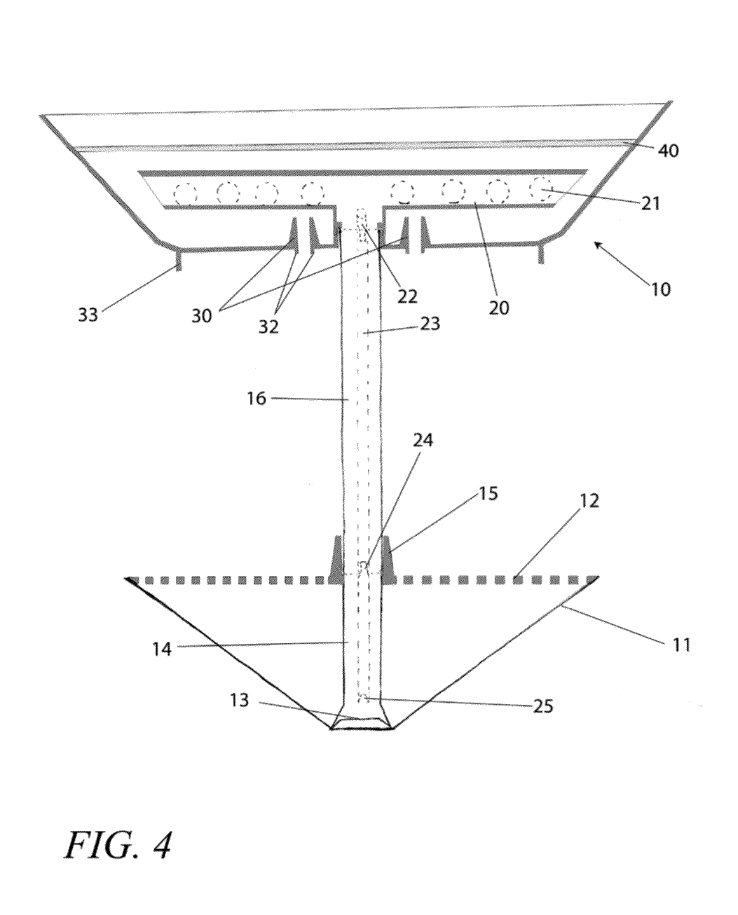

Referring now to FIGS. 1-4 of the present invention, an aquarium 31 has fish F and water W therein. A planter 10 rests upon aquarium 31. At the bottom of aquarium 31 is a layer of substrate 59 in which a solid waste capture funnel 11 (FIGS. 2 and 4) embedded in it. On top of solid waste capture funnel 11 is an undergravel filter screen 12, which then has aquarium substrate 60 above that. At the bottom of the solid waste capture funnel lies an opening 13 from lower riser tube section 14. In the center of undergravel filter screen 12 lies a riser tube junction 15 (that is connected to lower riser tube section 14) in which riser tube 16 is attached. Riser tube 16 rises through the middle of the tank and connects to planter 10 via planter opening 17. Within planter opening 17 lies a ring structure 18 that serves to halt the advance of riser tube 16 into a watering tube adaptor 19 that connects to watering tube 20. Watering tube 20 is open on either end in this embodiment, with watering holes 21 drilled, molded, or equivalent through its surface. Watering tube 20 connects to the planter via the watering tube adaptor 19, which is connected to planter 10.

An airline runs from an external air pump (not shown) through airline tubing (not shown) to the back of the planter and connects to an airline input junction (not shown). Connected to the airline input junction on the inside of the planter is a small piece of airline tubing (not shown) that connects to airline elbow 22 which transverses through watering tube adaptor 19. Airline elbow 22 points down toward the bottom of the aquarium in this embodiment, connecting to airline tube 23 that is located inside of riser tube 16. When riser tube 16 is inserted into planter opening 17, airline tube 23 and airline elbow 22 are aligned so that the opening at the top of airline tube 23 fits and locks into airline elbow 22. Airline tube 23 runs down the inside of riser tube 16 and connects at another airline junction 24 located within riser tube junction 15. The bottom of airline tube 23 connects to airline junction 24 in a similar manner to airline elbow 22. Finally, airline 24 runs down the inside of lower riser tube section 14 until it nears opening 13, where it releases air into riser tube 14 via an airline output 25.

Air released in airline output 25 create a suction through opening 13 when the aquarium is filled with water W, which then sucks water and waste up and into watering tube 20 and out through a plurality of watering holes 21. This water is then released over a mat of fibrous material 26 embedded with activated carbon 27, zeolite 28, and calcium carbonate 29. Water in the planter pools at the bottom of planter 10 and then drains via raised drainage holes 30, where it is directed down into aquarium 31 via drainage lips 32.

Planter 10 is shaped in a way that allows it to sit directly on a round aquarium and has bottom rim 33 to assist in its stability in sitting on said aquarium. There exists a cutout and groove (not shown) in bottom rim 33 at the back of planter under the aforementioned airline input junction. At the front of the planter exists a cutout portion 39 (FIGS. 1 and 2). At the back of the planter exists a grow light bracket 34 that allows an expandable grow light support 35 to be mounted. Expandable grow light support 35 is attached to a grow light hood 36, which has a wired bulb socket 37 attached underneath said hood. A grow light bulb 46 is illustrated in FIG. 2 that fits in said wired bulb socket 37. A light switch 47 juts out of switch hole 48 within light hood 36. Wiring 38 from bulb socket 37 runs through an opening within the expandable grow light support (not shown), then out through the back of the grow light bracket 34. This wiring system is meant to connect to a standard wall plug and then into a standard wall socket but is not shown in these figures.

Planter insert 40 holds net baskets 41 that are inserted through holes 42 within the planter insert. These net baskets also fit into holes 43 within the mat of fibrous material 26, which allows the net baskets to sit on the bottom of planter 10. In addition to holes 43 within fibrous material 26 are holes 45 which are located at the center of the material that allow riser tube junction 15 as well as raised drainage holes 30 to transverse the mat. Inserted into the net baskets 41 are plant growth plugs 44 in which a terrestrial plants 48 are grown.

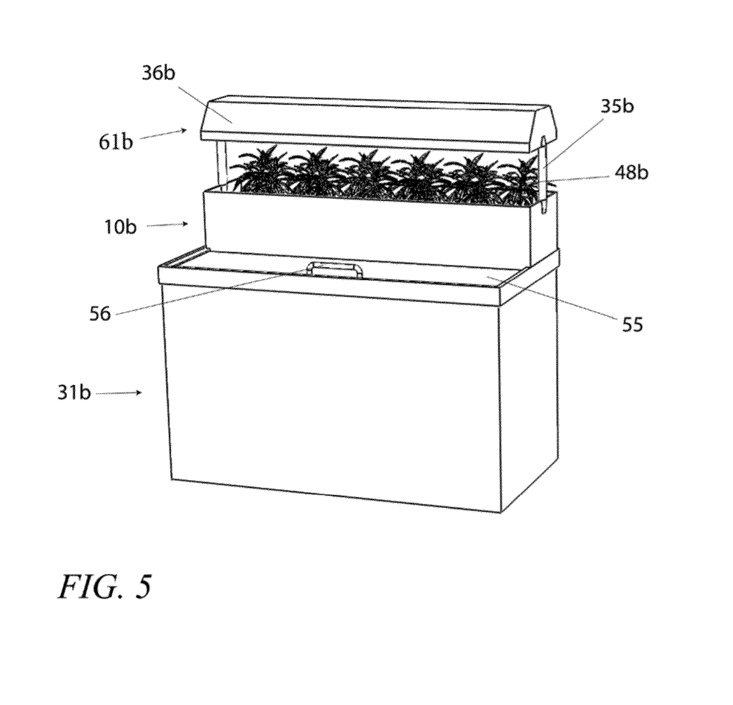

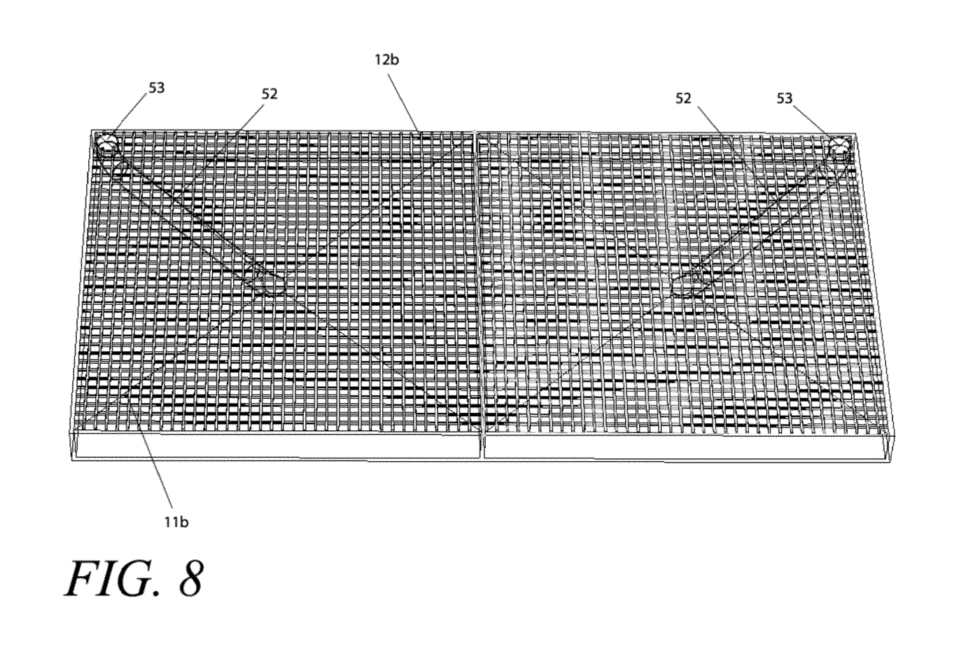

Another embodiment of this invention is shown in FIGS. 5-7 that show an embodiment suitable to a rectangular aquarium. All parts that are synonymous with the preferred embodiment are labeled with a ‘b’ suffix. There are a number of parts, however, that have been added to this embodiment that will be discussed here. Removable intake screen 49 shown in FIG. 5 acts in place of a funnel bottom system in one form of this embodiment. A standard undergravel filter 50 is also illustrated in this embodiment to show how removable intake screen 49 is an optional arrangement, where dual riser tubes 16b have the ability to connect to undergravel filter 50 via intake openings 51. Alternatively, an undergravel filter design like that shown in FIG. 8 could be used that implements the bottom funnel technology described in the previous embodiment that uses an equivalent undergravel screen 12b and funnel system 11b, but has an angled intake tube 52 that runs under the funnel portion lib to an intake opening 53 which then connects to riser tube 16b. Compressed air could power the pumping action of this system as well, as air from an external air pump travels through airline tubing (not shown) to airline input junction 63, which connects in a similar fashion to the preferred embodiment to airline tube 23b inside riser tube 16b and then air is released at output 25b. Airlift suction may not be enough power for larger aquariums; therefore it is assumed that an impellor pump system may be implemented in this or any other embodiment and that these systems would be equivalent.

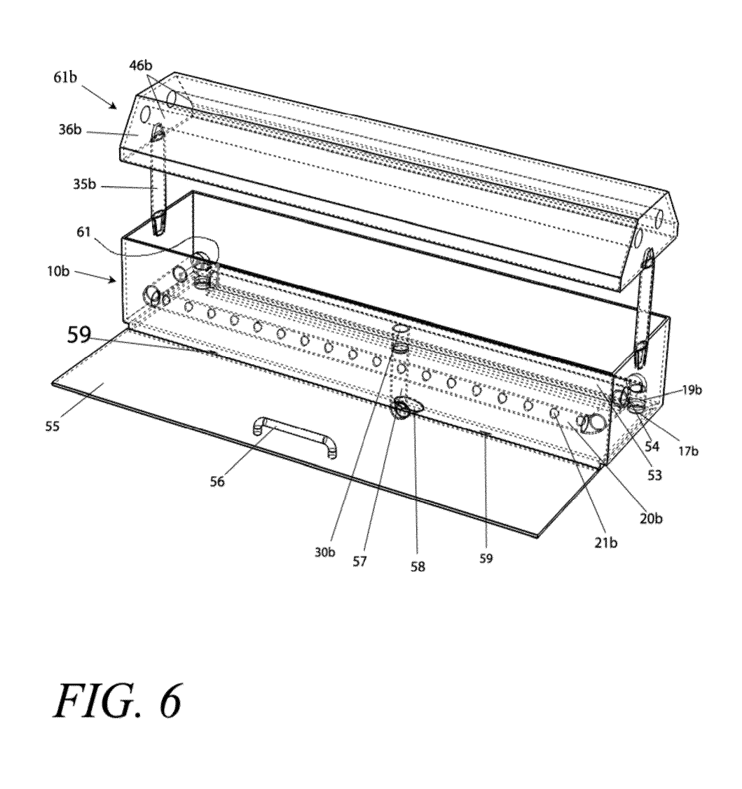

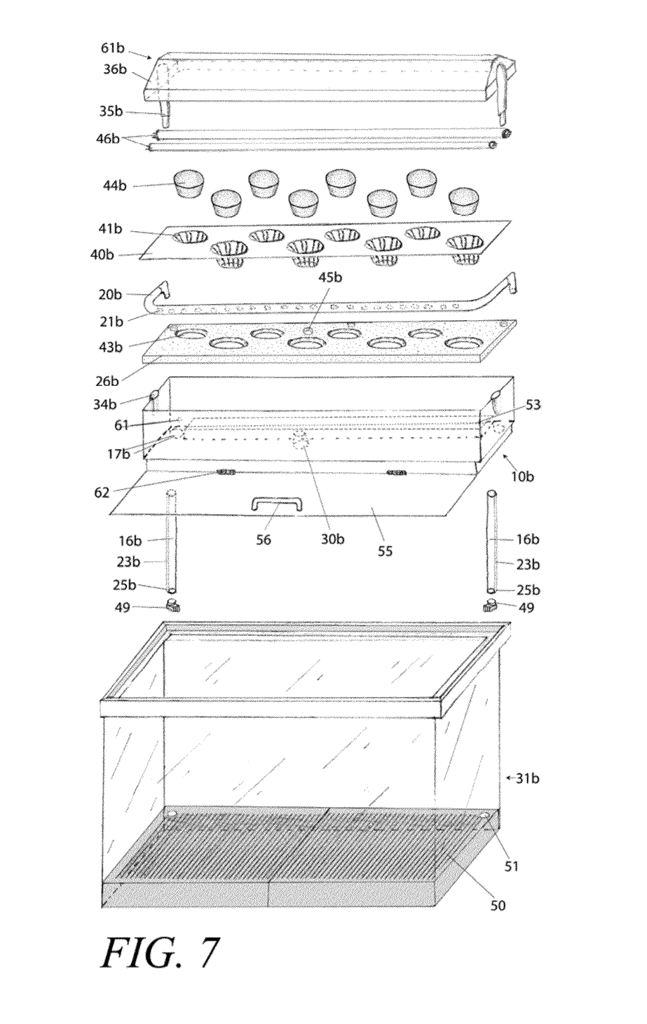

An aquarium light housing 53 and bulb 54 is also featured in this embodiment, and is located at the bottom of planter 10b in FIGS. 6 and 7. At the front of planter 10b an aquarium cover 55 with handle 56 is shown that connects to planter 10b via hinges 62. Attached to the bottom of planter 10b there is a single stand pipe that functions as a raised drainage hole 30b, but is attached to a drainage tube 57 and drain diffuser 58.

In the operation of this aquaponic invention, aquarium substrate 59 is set in the bottom of aquarium 31, solid waste capture funnel 11 is pressed into the substrate until it reaches the edge of said funnel. At this point filter screen 12 is set on top of solid waste capture funnel 11, and opening 13 in riser tube section 14 are aligned at the bottom of solid waste capture funnel 11. Filter screen 12 acts to stop aquarium substrate 60 from entering the solid waste capture funnel 11, while having holes large enough so that solid waste can make its way down through the substrate and into the solid waste capture funnel 11. Aquarium substrate 60 is added to the top of filter screen 12 but not higher than riser tube junction 15, keeping this junction clear and visible is necessary for riser tube 16 attachment. Water W can now be added to the system, as well as aquatic animals such as fish F. Riser tube 16 attaches to filter screen 12 via riser tube junction 15, and airline section 23 connects to airline junction 24 within the riser tube junction 15. Riser tube 16 is then inserted into the planter via planter opening 17 until it is stopped from advancing into watering tube 20 by ring structure 18. Airline section 23 attaches to airline elbow 22 in planter opening 17, which then connects to airline tubing toward an airline input junction located at the back of the planter (not shown). This connection system allows riser tube 16 to be removable for cleaning after the system has been in operation. Having an airline tube on the inside of a riser tube, as in this embodiment, makes for a smoother appearance and easier connection to airline junctions at the top and bottom of said riser tube. Positioning an airline tube on the outside of said riser tube, perhaps in an indented portion of the riser tube would work in a nearly identical fashion and is therefore considered an equivalent embodiment.

To power the airlift pumping mechanism, a standard air pump (not shown) or equivalent pneumatic pump that is connected to a power source (not shown) can be used, or another source of compressed air such as a pressurized tank of nitrogen gas. Airline tubing is connected from this pressurized gas port to the airline input junction at the back of the planter (not shown). Air now flows through each airline junction described, down the riser tubes 16 and 14, respectively, and is released out of airline output 25, creating bubbles that rise in the riser tubes and out through the plurality of holes 21 in watering tube 20. Airline output 25 has a close juxtaposition to opening 13 to create enough suction within solid capture funnel 11 to transport solid waste accumulation up and into the mat of fibrous material 26 where it is trapped for the degradation by microorganisms and then the roots of terrestrial plants 48.

Planter 10 is preferably, but not necessarily made of polyvinyl chloride or the like. Planter 10 is designed in such a way that bottom rim 33 juts out from the bottom of the planter, creating a stable ring that resists tipping and falling off of aquarium 31. The cutaway at the back of planter 10 in bottom rim 33 (not shown) creates an area for an aquarium heater to be mounted inside the aquarium. Cutout portion 39 at the front of the planter allows a port at which to feed the aquatic animals, add water to the system, or take samples for water quality testing etc. In the center of planter 10 is watering tube adaptor 19, which consists of a raised cylinder attached to the bottom of planter 10. Watering tube 20 is removable in this system and is attached to watering tube adaptor 19. At the back of planter 10 exists a grow light adaptor 34 that allows a grow light accessory 61 to be supported above the plants for increased plant growth rates. At the bottom of planter 10 is a removable mat of fibrous material 26 that is embedded with activated carbon 27 and zeolite 28 as chemical filtration mechanisms to absorb nitrogenous and gas compounds dissolved in the water and act to concentrate waste particles for use by the absorption of the plant roots. These parts also act as the hydroponic growth media for this system. Calcium carbonate particles 29 are also embedded within this mat of fibrous material 26 to aid with pH buffering of the aquarium water. Raised drainage holes 30 fit through holes 45 within the mat of fibrous material 26. These raised drainage holes 30 function to create a pool of water in the bottom of the planter that aids in small particle settling, increases the adsorption time for the activated carbon 27 and zeolite 28 particles, and are resistant to roots growing through them and into the aquarium below. Drainage lip 32 acts to direct the water back into the aquarium, where if this lip did not exist water would bead across the bottom of planter 10 and drip off of bottom ring 33. Planter insert 40 holds net baskets 41 (which fit through holes 43 in the mat of fibrous material 26), which in turn hold natural plant growth plugs 44. This planter insert is removable as are the plant growth plugs and add a modular aspect to this invention. The growth plugs allow seeds to be germinated or plant clones to be propagated and removed easily while this invention is in operation. The plant growth plugs are made of inert material such as rockwool, coconut fiber or peat and is embedded with a small amount of organic fertilizer and lime to supplement nutrients to the plant and buffer the pH of the tank, respectively. A person skilled in the art could add extra layers of hydroponic media above the mat of fibrous material, remove the mat altogether, or replace the planter insert with a bed of hydroponic media such as expanded clay, rock wool, pearlite or the like without changing the scope of this invention.

Describing now the operation of grow light accessory 61, an expandable light support 35 attaches to the light hood 36, which contains a light socket 37, bulb 46, switch 47, and wires 38. The expandable light support 35 is expandable to be able to raise and lower the grow light as the plants grow. The light bulb 46 can be fluorescent, incandescent, LED or the like while its only necessary requirement is to give off light in a suitable spectrum for efficient plant growth. Presently, the wires from light socket run down through the expandable light support 35, exiting near the airline input junction. A person skilled in the art could make the wiring for this socket in a variety of ways, shapes or forms for a safe and easy to use system to power this light, or perhaps utilize a solar panel and DC converter to power the air pump or light.

In the operation of the embodiment of this invention shown in FIGS. 5-7, filter screen 49 is attached to two riser tubes 16b with similar construction to riser tube 16, with the difference being that the airline outlet 25b is at the bottom of riser tube 16b. Alternatively, riser tube 16b can be attached to a standard undergravel filter 50 via input hole 51 as shown in FIG. 7 and used to extract solid waste from the bottom of the aquarium as well as increase the total surface area available for natural biofiltration. FIG. 8 illustrates a solid waste capture funnel design for a rectangular aquarium that is attached to riser tube 16b in the same fashion as an undergravel filter. This design has distinct advantages over traditional undergravel filter designs in that the funnel concentrates waste toward the center, where a vacuum tube 52 pulls the waste up and into riser tube 16b and then up into planter 10b.

Connected to the front of this embodiment, as seen in FIGS. 5, 6, and 7 is an aquarium cover 55 with handle 56, attached to the bottom of planter 10b via hinges 62. This cover is used to limit the evaporative water loss from the aquarium as well as provide and easy access area to the aquarium. At the back of planter 10b exists light housing 53 and bulb 54 that is used to illuminate the inside of the aquarium. Wiring is not shown for the aquarium lighting or plant lighting in this embodiment, as one skilled in the art could wire fluorescent, LED or equivalent lighting solutions in a standard way that would be suitable for this embodiment. A gasket would also need to be included to be placed between light housing 53 and planter 10b for this light to keep moisture from the aquarium out and decrease the chance of electrical shock. A similar aquarium lighting system could be implemented in the first embodiment of this invention but is not included at this time.

Attached to the bottom of planter 10b is a stand pipe 30b, shown in FIG. 6. This stand pipe functions similarly to raised drainage holes 30, but connects to a drain pipe 57 and then to drain diffuser 58 that acts to distribute the water evenly without disturbing the aquarium components. A bell siphon system typically used in aquaponic systems could be added to this stand pipe as an equivalent but is not used in this specific embodiment.

Thus, it is apparent that there has been provided, in accordance with the invention, an aquaponic system for use with aquatic animals in aquariums that fully satisfies the objects, aims and advantages set forth above. Although certain example methods, functions, features, components, and abilities have been described herein, the scope of coverage of this invention is not limited thereto. On the contrary, this invention covers all methods, functions, features, components, and abilities fairly falling within the scope of the description either literally or under the doctrine of equivalents.

With respect to the above description then, it is to be realized that the optimum methods, functions, features, components, and operation of the aquaponic planter are deemed readily apparent and obvious to one skilled in the art, and all equivalent relationships to those described in the description are intended to be encompassed by the aquaponic planter.

Therefore, the foregoing is considered as illustrative only of the principles of the aquaponic planter. Further, since numerous modifications and changes will readily occur to those skilled in the art, it is not desired to limit the aquaponic planter to the exact construction and operation shown and described, and accordingly, all suitable modifications and equivalents may be resorted to, filling within the scope of the aquaponic planter. While the above description describes various embodiments of the present invention, it will be clear that the present invention may be otherwise easily adapted to fit any configuration where an aquaponic planter for use in the home, office, or school is desired or required.

As various changes could be made in the above methods, functions, features, components, and abilities without departing from the scope of the invention, it is intended that all matter contained in the above description shall be interpreted as illustrative and not in a limiting sense.

What is claimed is:

1. An aquaponic conversion kit for converting an aquarium containing aquatic animals into an aquaponic system, comprising:
a planter configured to rest upon an aquarium, a hydroponic growth media and chemical filtration components located within the planter, a watering tube running through the planter that allows for the distribution of water and aquatic animal solid waste into the planter, a riser tube affixed to the planter that conveys the water and the aquatic animal solid waste from the aquarium to the planter, an airline located within the riser tuber that conveys air to the lower section of the riser tube, said air creating an airlift effect within the riser tube that causes the water and aquatic animal solid waste to travel through the riser tube to the planter, a solid waste capture funnel affixed to the lower section of the riser tube that concentrates the aquatic animal solid waste, and an undergravel filter screen located on the top of the solid waste capture funnel that aids in the capture of aquatic animal solid waste.

2. The aquaponic conversion kit of claim 1, wherein the roots of terrestrial plants grow in the hydroponic growth media and the chemical filtration components.

3. The aquaponic conversion kit of claim 1, wherein water dispensed from the watering tube trickles through the hydroponic growth media and chemical filtration components then back into the aquarium through raised drainage holes.

4. The aquaponic conversion kit of claim 3, wherein the raised drainage holes allow fine particles to settle out.

5. The aquaponic conversion kit of claim 1, further comprising a layer of substrate located at the bottom of the aquarium in which the solid waste capture funnel is embedded.

6. The aquaponic conversion kit of claim 1, wherein the planter further comprises a planter insert containing net baskets, the net baskets containing plant growth plugs.

7. The aquaponic conversion kit of claim 1, wherein the planter further comprises an attachment for attaching a grow light.

8. An aquaponic conversion method, comprising:
converting an existing aquarium to an aquaponic system by providing a planter that is configured to attach to the top of the aquarium, providing hydroponic growth media and chemical filtration components within the planter in which the roots of terrestrial plants can grow, gathering solid waste from aquatic animals residing within the aquarium, transporting the solid and liquid waste and water from the aquarium to the hydroponic growth media and chemical filtration components by creating an airlift effect within a riser tube that extends into the aquarium, filtering the solid waste from the water so that it may be utilized by the roots of the terrestrial plants growing in the hydroponic growth media, allowing gravity to cause the water to drip back into the aquarium through drainage holes located in the bottom of the planter.

9. The method of claim 8, wherein the chemical filtration components capture the solid waste so that it can degrade and be utilized by the terrestrial plants.

10. The method of claim 8, wherein the solid waste is gathered by concentrating it in a solid waste capture funnel.

11. The method of claim 10, wherein the solid waste capture funnel contains an undergravel filter screen that acts to prevent gravel or an aquarium substrate from entering the riser tube.

12. The method of claim 8, wherein the airlift effect is created by pumping air through an airline residing within the riser tube, the airline terminating in the bottom section of the riser tube so that the air rises through the water in the riser tube upon exiting the airline.

13. The method of claim 8, wherein the solid waste is filtered from the water in the planter by the chemical filtration components.

14. The method of claim 8, wherein the drainage holes are raised from the bottom of the planter so that fine particles settle out of the water.

15. An aquaponic apparatus, comprising:
a top portion shaped to fit on top of an existing aquarium, hydroponic growth media and chemical filtration components located within the top portion that allow the roots of a terrestrial plant to grow, a riser tube that allows water and solid and liquid waste excreted from an aquatic animal to travel from the existing aquarium to the top portion, a riser tube bottom opening located in the existing aquarium above the floor of the aquarium, a means for causing water and the solid waste to travel from the existing aquarium up the riser tube and into the top portion, drainage holes that permit the water to drip back into the existing aquarium by way of gravity, and a removable intake screen located in the riser tube bottom opening that prevents unwanted objects from entering into the riser tube.

16. The aquaponic apparatus of claim 15, wherein the top portion is shaped to fit onto a rectangular existing aquarium.

17. The aquaponic apparatus of claim 15, wherein the top portion further comprises a planter insert containing net baskets.

18. The aquaponic apparatus of claim 17, wherein plant growth plugs are inserted into the net baskets, the plant growth plugs being where a terrestrial plant is grown.

19. The aquaponic apparatus of claim 15, wherein the means for causing water and the solid waste to travel from the existing aquarium up the riser tube is an airlift effect created by pumping compressed air down an airline residing within the riser tube and releasing the air within the riser tube.

20. The aquaponic apparatus of claim 15, wherein the means for causing water and the solid waste to travel from the existing aquarium up the riser tube is created by an impellor.
